(19) United States
(12) Patent Application Publication
(10) Pub. No.: US 2017/0033399 A1
(43) Pub. Date: Feb. 2, 2017

(54) SECONDARY BATTERY AND METHOD FOR MANUFACTURING THE SAME

(71) Applicant: NEC ENERGY DEVICES, LTD., Sagamihara-shi (JP)

(72) Inventors: Ai FUJISAWA, Kanagawa (JP); Shin TANAKA, Kanagawa (JP)

(73) Assignee: NEC ENERGY DEVICES, LTD., Sagamihara-shi (JP)

(21) Appl. No.: 15/302,634

(22) PCT Filed: Mar. 6, 2015
(86) PCT No.: PCT/JP2015/056591

§ 371 Date: Oct. 7, 2016

(30) Foreign Application Priority Data
Apr. 11, 2014 (JP) 2014-081732

(51) Int. Cl. H01M 10/0525; H01M 4/525; H01M 4/505; H01M 4/58; H01M 2/16; H01M 10/0585; H01M 10/0564; H01M 10/0561; H01M 2/02; H01M 4/1315; H01M 4/66

(52) U.S. Cl. CPC H01M 10/0525; H01M 4/1315; H01M 4/525; H01M 4/505; H01M 4/5825; H01M 4/667; H01M 4/662; H01M 4/669; H01M 10/0585; H01M 10/0564; H01M 10/0561; H01M 2/0275; H01M 2/026; H01M 2/0262; H01M 2/0207; H01M 2/024; H01M 2/162; H01M 2/1653; H01M 2220/20; H01M 2220/30; H01M 2300/0037

(57) ABSTRACT

A secondary battery includes an laminated electrode in which positive electrode (1) and a negative electrode are arranged with a separator interposed therebetween. Positive electrode collector foil (3) is made of aluminum or an aluminum alloy. Positive electrode mixture layer (2) includes a positive electrode active material containing nickel and lithium. Protective layer (4) formed between positive electrode collector foil (3) and positive electrode mixture layer (2) includes a plurality of carbon particles (5). Carbon particles (5) are thin flakes which have principal plane (5a) and thickness (5b) orthogonal to principal plane (5a) and in which length L1 in one direction of principal plane (5a), length L2 in a direction orthogonal to the one direction within principal plane (5a), and length L3 in the direction of thickness (5b) satisfy the relationships of 5≧(L1/L2)≧1, (L1/L3)≧5, L2>L3, and L1≧4 μm. Within protective layer (4), principal plane (5a) intersects the thickness direction of protective layer (4). The average thickness of protective layer (4) is not less than 10 μm and not more than 100 μm.

### TECHNICAL FIELD

The present invention relates to a secondary battery and a method for manufacturing the same.

### BACKGROUND ART

Secondary batteries are becoming widely used as power supplies for vehicles and household appliances, not just as power supplies for portable devices such as mobile phones, digital cameras and laptop computers. From among the different kinds of secondary batteries, lithium ion secondary batteries, which have a high-energy density and which are lightweight, are energy storage devices that have become essential in daily life.

The secondary battery is configured in such a manner that a battery electrode assembly (laminated electrode) having a sheet-like positive electrode and a sheet-like negative electrode that are separated from each other to be laminated with a separator interposed therebetween is sealed together with an electrolyte in an exterior container. The positive electrode has a positive electrode mixture layer which includes a positive electrode active material and which is formed in one surface or both surfaces of positive electrode collector foil, and the negative electrode has a negative electrode mixture layer which includes a negative electrode active material and which is formed in one surface or both surfaces of negative electrode collector foil.

In the lithium ion battery, when the positive electrode that has a lithium nickelate based positive electrode active material and positive electrode collector foil made of aluminum or an aluminum alloy is used, the problem of corrosion occurs in the positive electrode. Specifically, when an aqueous solution (slurry) including the positive electrode active material is applied on the positive electrode collector foil, the lithium nickelate of the positive electrode active material reacts with water in the aqueous solution to generate LiOH, causing the aqueous solution to have a strong base. An aluminum oxide layer is easily formed on the surface of the positive electrode collector foil including aluminum, and the corrosion resistance of this aluminum oxide layer is low. As a result, when the aqueous solution which has a strong base is applied on the positive electrode collector foil that has the aluminum oxide layer on the surface, the positive electrode collector foil corrodes to facilitate peeling of the positive electrode mixture layer or to generate various bubble traces on the surface of the positive electrode mixture layer. To prevent the generation of LiOH, the positive electrode active material may be dissolved in a solvent to prepare a coating liquid. However, solvents include substance of concern (NMP) in many cases, and thus their use is preferably limited.

Patent Document 1 discloses a configuration where a corrosion resistant layer made of tungsten carbide is formed between positive electrode collector foil made of aluminum and a positive electrode active material. Patent Document 2 discloses a configuration where a conductive base film including flaked graphite is formed between the collector foil and an active material.

### PRIOR ART DOCUMENT

### Patent Document

Patent Document 1: JP2010-21075A

Patent Document 2: JP2012-156109A

### SUMMARY OF INVENTION

### Problems to Be Solved by the Invention

As described above, it is desired that without using any solvent including a substance of concern, a positive electrode mixture layer be formed by applying an aqueous solution having a positive electrode active material dissolved in water on a positive electrode collector foil.

The configuration described in Patent Document 1 has a corrosion resistant layer made of the tungsten carbide, thus providing the effect of protecting the positive electrode collector foil. However, in order to form the corrosion resistant layer, a physical vapor deposition method such as sputtering, vacuum vapor deposition, or ion plating, or a chemical vapor deposition method (vapor phase growth method) such as CVD must be performed, thus complicating the manufacturing process of the secondary battery.

In the configuration described in Patent Document 2, conductive base coating material reduces contact resistance between the collector foil and the active material, thus improving adhesion between the collector foil and the mixture layer. However, because corrosion of the collector foil that is caused by the chemical reaction of the active material with water is not taken into account, measures to prevent corrosion are not adopted.

It is therefore an object of the present invention to provide a secondary battery that can be easily manufactured using inexpensive materials and in which corrosion of the collector foil, that is caused by the chemical reaction of active material with water, can be reduced, and to provide a manufacturing method thereof.

### Means to Solve the Problem

According to the present invention, a secondary battery includes an laminated electrode in which a positive electrode including positive electrode collector foil and a positive electrode mixture layer and a negative electrode including negative electrode collector foil and a negative electrode mixture layer are arranged with a separator interposed therebetween. The positive electrode collector foil is made of aluminum or an aluminum alloy, the positive electrode mixture layer includes a positive electrode active material containing at least nickel and lithium, and a protective layer is formed between the positive electrode collector foil and the positive electrode mixture layer. The protective layer includes a plurality of carbon particles. The carbon particles are thin flakes which have a principal plane and a thickness orthogonal to the principal plane and in which length L1 in one direction of the principal plane, length L2 in a direction orthogonal to the one direction within the principal plane, and length L3 in the direction of the thickness satisfy the relationships of 5≧(L1/L2)≧1, (L1/L3)≧5, L2>L3, and L1≧4 μm. The carbon particles are arranged so that within the protective layer, the principal plane intersects at least the thickness direction of the protective layer. The average thickness of the protective layer is not less than 10 μm and not more than 100 μm.

According to the present invention, a method for manufacturing a secondary battery that includes an laminated electrode in which a positive electrode including positive electrode collector foil and a positive electrode mixture layer and a negative electrode including negative electrode collector foil and a negative electrode mixture layer are arranged with a separator interposed therebetween, includes the step of forming the positive electrode by forming a protective layer including carbon particles on the positive electrode collector foil made of aluminum or an aluminum alloy and by forming the positive electrode mixture layer including a positive electrode active material on the protective layer. During the formation of the protective layer, a plurality of flaky carbon particles which have a principal plane and a thickness orthogonal to the principal plane and in which length L1 in one direction of the principal plane, length L2 in a direction orthogonal to the one direction within the principal plane, and length L3 in the direction of the thickness satisfy the relationships of 5≧(L1/L2)≧1, (L1/L3)≧5, L2>L3, and in which L1≧4 μm is arranged so that within the protective layer, the principal plane intersects at least the thickness direction of the protective layer. During the formation of the positive electrode mixture layer, an aqueous solution that includes a positive electrode active material and that has viscosity set to be not less than 5000 mPas and not more than 10000 mPas is applied on the protective layer, and then dried.

### Advantageous Effects of Invention

According to the present invention, since the flaky carbon particles within the protective layer physically block a base in the aqueous solution from moving in the thickness direction in the protective layer, it is difficult for the base to reach the positive electrode collector foil, and thus corrosion of the positive electrode collector foil due to the base is reduced. Accordingly, the surface state of the positive electrode is smooth and satisfactory. The carbon particles can provide high conductivity and high energy density. Moreover, as the average thickness of the protective layer is not less than 10 μm and not more than 100 μm, the invention provides the effect of reducing the corrosion of the positive electrode collector foil and reducing the peeling of each layer. As a result, a secondary battery can be provided with a positive electrode that has excellent corrosion resistant properties and excellent properties that reduce layer peel-off.

### BRIEF DESCRIPTION OF DRAWINGS

FIG. 1A is a plan view illustrating the basic structure of a laminated type secondary battery according to an exemplary embodiment of the present invention.

FIG. 1B is a sectional view cut along the line A-A illustrated in FIG. 1A.

FIG. 2A is an enlarged sectional view illustrating the main portion of the positive electrode of the secondary battery illustrated in FIGS. 1A and 1B.

FIG. 2B is a much enlarged schematic perspective view illustrating a carbon particle contained in a protective layer of the positive electrode illustrated in FIG. 2A.

FIG. 3 is a plan view illustrating the surface state of a positive electrode having no protective layer.

FIG. 4 is a plan view illustrating the surface state of the positive electrode illustrated in FIG. 2A.

FIG. 5A is a plan view illustrating the positive electrode forming step of a method for manufacturing a secondary battery according to the present invention.

FIG. 5B is a plan view illustrating a positive electrode cut to be formed after the step illustrated in FIG. 5A.

FIG. 6A is a plan view illustrating the negative electrode forming step of the method for manufacturing the secondary battery according to the present invention.

FIG. 6B is a plan view illustrating a negative electrode cut to be formed after the step illustrated in FIG. 6A.

FIG. 7A is a plan view illustrating another example of the positive electrode forming step of the method for manufacturing the secondary battery according to the present invention.

FIG. 7B is a plan view illustrating a positive electrode cut to be formed in the step illustrated in FIG. 7A.

FIG. 8 is a plan view illustrating a step subsequent to the step illustrated in FIG. 7A in the method for manufacturing the secondary battery according to the present invention.

### DESCRIPTION OF EXEMPLARY EMBODIMENTS

Hereinafter, the exemplary embodiments of the present invention will be described with reference to the drawings.

### Basic Structure of Secondary Battery

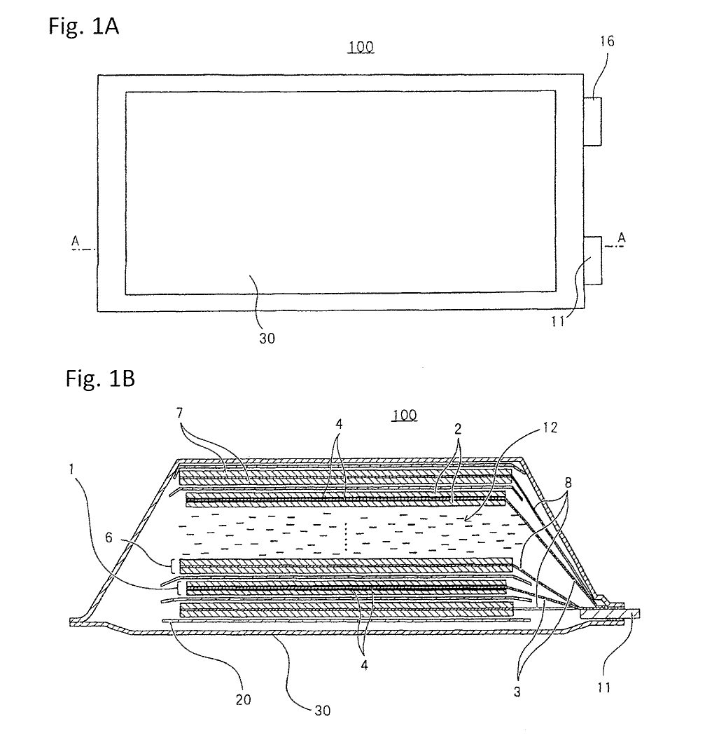

FIGS. 1A and 1B schematically illustrate an example of the configuration of a laminated type lithium ion secondary battery that is based on the present invention. Lithium ion secondary battery 100 according to the present invention includes an laminated electrode (battery electrode assembly) in which positive electrodes (positive electrode sheets) 1 and negative electrodes (negative electrode sheet) 6 are alternately laminated with separators 20 interposed therebetween. The laminated electrode is housed together with electrolyte 12 in an exterior container formed of flexible film 30. One end of positive electrode terminal 11 is connected to positive electrode 1 of the laminated electrode, one end of negative electrode terminal 16 is connected to negative electrode 6, and the other end side of positive electrode terminal 11 and the other end side of negative electrode terminal 16 extend to the outside of flexible film 30. FIG. 1B illustrates electrolyte 12 and omits a part of layers (layers located in intermediate part in thickness direction) that constitute the laminated electrode.

Positive electrode 1 includes positive electrode collector foil 3, positive electrode mixture layer 2 formed on positive electrode collector foil 3, and protective layer 4 located between positive electrode collector foil 3 and positive electrode mixture layer 2. Negative electrode 6 includes negative electrode collector foil 8 and negative electrode mixture layer 7 formed on negative electrode collector coil 8. Protective layer 4 provided on positive electrode 1 will be described below.

Each uncoated part in which positive electrode mixture layer 2 is not provided on positive electrode collector foil 3 and each uncoated part in which negative electrode mixture layer 7 is not provided on negative electrode collector foil 8 are used as tabs to connect to the electrode terminals (positive electrode terminal 11 or negative electrode terminal 16). Positive electrode tabs connected to positive electrode 1 are arranged on positive electrode terminal 11, and interconnected integrally with positive electrode terminal 11 by ultrasonic welding or the like. Negative electrode tabs connected to negative electrode 6 are arranged on negative electrode terminal 16, and interconnected integrally with negative electrode terminal 16 by ultrasonic welding or the like. Then, the other end of positive electrode terminal 11 and the other end of negative electrode terminal 16 are respectively drawn to the outside of the exterior container. The external size of the coated part (negative electrode mixture layer 7) of negative electrode 6 is larger than that of the coated part (positive electrode mixture layer 2) of positive electrode 1, and smaller than that of separator 20.

In this secondary battery, as positive electrode active materials included in positive electrode mixture layer 2, for example, the following materials can be mentioned: a layered oxide based material such as, LiNiO₂, LiNi₍₁₋ₓ₎CoO₂, LiNiₓ(CoAl)₍₁₋ₓ₎O₂, Li₂MnO₃—LiNiO₂, or LiNiₓCo_{y}Mn_{(1-x-y)}O₂, a spinel based material such as LiMn_{1.5}Ni_{0.5}O₄, or LiMn₍₂₋ₓ₎NiₓO₄, an olivine based material such as LiNiPO₄, and an olivine fluoride based material such as Li₂NiO₄F or Li₂NiO₄F, or a mixture of two or more of these materials can be used.

As a negative electrode active material included in negative electrode mixture layer 7, a carbon material such as, graphite, amorphous carbon, diamond carbon fullerene, carbon nanotube, or carbon nanohorn, a lithium metallic material, an alloy based material such as silicon or tin, an oxide based material such as Nb₂O₅ or TiO₂, or a combination of these can be used.

Materials for positive electrode mixture layer 2 and negative electrode mixture layer 7 may be mixed agents to which binders, conductive auxiliary agents or the like are added as occasion demands. As the conductive auxiliary agent, one or a combination of two or more of carbon black, a carbon fiber, and graphite can be used. As the binder, polyvinylidene fluoride (PVDF), polytetrafluoroethylene, carboxymethyl cellulose, or modified acrylonitrile rubber particles can be used.

Positive electrode collector foil 3 is preferably made of aluminum or an aluminum alloy. For negative electrode collector foil 8, copper, stainless steel, nickel, titanium, or an alloy of these can be used.

For electrolyte 12, one or a mixture of two or more organic solvents including cyclic carbonates such as ethylene carbonate, propylene carbonate, vinylene carbonate or butylene carbonate, chain carbonates such as ethyl methyl carbonate (EMC), diethyl carbonate (DEC), dimethyl carbonate (DMC), or dipropyl carbonate (DPC), aliphatic carboxylic acid esters, γ-lactones such as γ-butyrolactone, chain ethers, and cyclic ethers can be used. Further, lithium salts can be dissolved in such an organic solvent.

Separator 20 mainly includes a resin porous film, a woven fabric, an unwoven fabric or the like, and as a resin component, for example, a polyolefin resin such as polypropylene or polyethylene, a polyester resin, an acrylic resin, a styrene resin, a nylon resin or the like can be used. A polyolefin microporous film is particularly preferable because of its high ion permeability and strong properties for physically isolating the positive electrode and the negative electrode from each other. When necessary, a layer including inorganic particles may be formed in separator 20, and the inorganic particles may be an insulating oxide, nitride, sulphide, or carbide, and may preferably include TiO₂ or Al₂O₃.

For the exterior container, a case including flexible film 30, a can case or the like can be used, and flexible film 30 is preferably used from the standpoint of achieving light battery weight. For flexible film 30, a film having resin layers formed on the front surface and the rear surface of a metal layer that is a base material can be used. For the metal layer, a barrier layer that prevents the leakage of electrolyte 12 or the penetration of moisture from the outside can be selected, and aluminum or stainless steel can be used. A heat-fusible resin layer such as modified polyolefin is provided in at least one surface of the metal layer. The exterior container is formed by arranging the heat-fusible resin layers of flexible film 30 oppositely to each other and by heat-fusing the surroundings of the portion to house the laminated electrode. A resin layer such as a nylon film or a polyester film can be provided in the surface of the exterior container opposite to the surface in which the heat-fusible resin layer has been formed.

A terminal made of aluminum or an aluminum alloy can be used for positive electrode terminal 11, and a terminal made of copper or a copper alloy, or such a material plated with nickel can be used for negative electrode terminal 16. The other end sides of respective terminals 11 and 16 are drawn to the outside of the exterior container. In the places of respective terminals 11 and 16 that correspond to the heat-fused parts of the outer peripheral portion of the exterior container, heat-fusible resin layers can be provided in advance.

### Detailed Structure of Positive Electrode

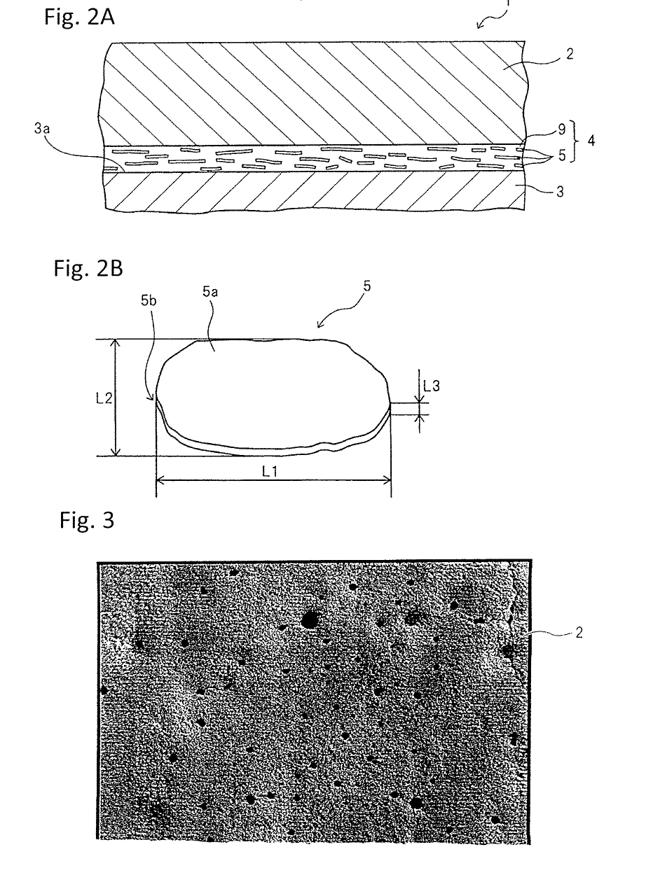

FIG. 2A is an enlarged schematic sectional view illustrating a portion of positive electrode 1 that is the main feature of the present invention. According to the exemplary embodiment, protective layer 4 is provided between positive electrode collector foil 3 containing aluminum or an aluminum alloy and positive electrode mixture layer 2 including a positive electrode active material that is a compound containing lithium and nickel. Protective layer 4 includes many carbon particles 5 and binder 9. The average thickness of protective layer 4 is not less than 10 μm and not more than 100 μm, preferably not less than 40 μm and not more than 100 μm. Each carbon particle 5 is a thin flake that has principal plane 5a and thickness 5b orthogonal to the principal plane. The carbon particles of the exemplary embodiment are thin flakes that satisfy the relationships of 5≧(L1/L2)≧1, (L1/L3)≧5, L2>L3, and L1≧4 μm, in which L1 indicates a length in one direction (mainly longitudinal direction) of principal plane 5a, L2 indicates a length in a direction (orthogonal direction) orthogonal to the one direction (longitudinal direction) within principal plane 5a, and L3 indicates a length in the direction of the thickness. In each carbon particle 5, each principal plane 5a intersects (nonparallel to) the thickness direction of protective layer 4, and each thickness 5b intersects (nonparallel to) protective layer forming surface 3a of positive electrode collector foil 3. Preferably, thickness 5b of each carbon particle 5 is substantially orthogonal to protective layer forming surface 3a, and principal plane 5a of each carbon particle 5 is substantially parallel to protective layer forming surface 3a. Other than these, there is no particular restriction on the arrangement of carbon particles 5 in protective layer 4, but rather the carbon particles are randomly arranged. In other words, the one direction (longitudinal direction) may be any direction within principal plane 5a. When seen in plane (in the direction orthogonal to protective layer forming surface 3a), many carbon particles 5 partially overlap one another (shift to overlap one another in scale-like manner (imbrication manner)).

According to this configuration, since carbon particles 5 of protective layer 4 physically block the movement of a base (e.g., LiOH) generated by the reaction of the positive electrode active material (e.g., lithium nickelate) of positive electrode mixture layer 2 with water, the amount of base that reaches positive electrode collector foil 3 is reduced. This reduces damage to positive electrode collector foil 3 (mainly, aluminum or aluminum alloy) caused by the base (e.g., LiOH), thus enabling positive electrode mixture layer 2 that is formed thereon to be a smooth flat surface.

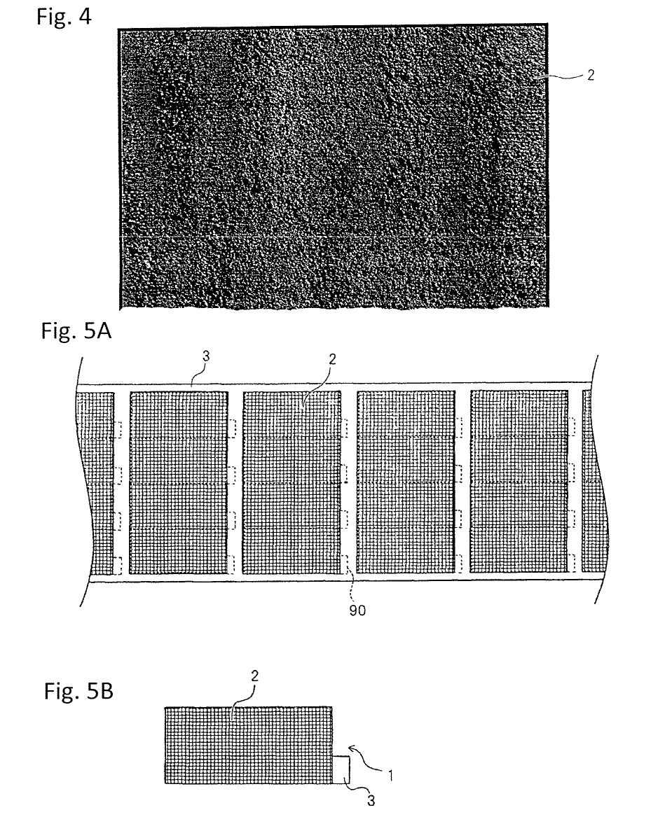

FIG. 3 illustrates a state where positive electrode collector foil 3 is damaged by a base in positive electrode 1 in which protective layer 4 is not present to form uneven patterns on the surface of positive electrode mixture layer 2. On the other hand, FIG. 4 illustrates the state of the surface of positive electrode mixture layer 2 according to the exemplary embodiment. The comparison of FIG. 3 with FIG. 4 clearly shows that the surface state of positive electrode mixture layer 2 according to the exemplary embodiment is satisfactorily flat and smooth. Thus, excellent battery characteristics can be provided.

When protective layer 4 made of metal oxide or the like is formed, the functionality of positive electrode 1 may be insufficient due to low conductivity and low energy density. However, protective layer 4 including carbon particles 5 according to the exemplary embodiment is high in both conductivity and energy density, thus enabling positive electrode 1 to have an sufficient and excellent function.

As described above, according to the present invention, flaky carbon particles 5 that satisfy the relationships of 524 (L1/L2)≧1, (L1/L3)≧5, L2>L3, and L1≧4 μm are arranged so that at least principal plane 5a intersects the thickness direction of protective layer 4 (preferably, principal plane 5a is substantially parallel to protective layer forming surface 3a). Accordingly, carbon particles 4 physically block the movement of water and a base (e.g., LiOH) mixed with water in the thickness direction in protective layer 4. As a result, it is difficult for the base to reach positive electrode collector foil 3, and thus the corrosion of positive electrode collector foil 3 by the base is reduced. Accordingly, the surface state of positive electrode mixture layer 2 is smooth and satisfactory. In addition, carbon particles 5 can provide conductivity and an energy density that is higher than metal oxide or the like. Thus, positive electrode 1 has an excellent function.

Moreover, according to the exemplary embodiment, the average thickness of protective layer 4 is not less than 10 μm and not more than 100 μm, preferably not less than 40 μm and not more than 100 μm, thus enabling positive electrode 1 of the secondary battery to have an excellent function. Table 1 below shows the result of a specific experiment in regard to this point. Specifically, when the thickness of protective layer 4 was less than 10 μm, it was confirmed that the application of slurry (aqueous solution) including a positive electrode active material containing nickel and lithium on positive electrode collector foil 3 made of aluminum or an aluminum alloy aggravated the corrosion of positive electrode collector foil 3 thus making positive electrode collector foil 3 unfit for use as positive electrode 1 of the secondary battery. When protective layer 4 was not less than 10 μm and not more than 20 μm, a production yield is bad because some secondary batteries which have insufficient initial capacities were manufactured, but other secondary batteries that have sufficient initial capacities may be usable without problems. An analysis of the reason for the reduction in initial capacity suggested that cause was very small cracks generated between positive electrode mixture layer 2 and protective layer 4. Regarding this problem, defective products are easily detected and removed by checking the initial capacity of a manufactured secondary battery. When protective layer 4 was not less than 20 μm and not more than 40 μm, while cycle characteristics were good with no corrosion detected in positive electrode collector foil 3, the problem in which secondary batteries were configured such that their initial capacities were small could not be completely avoided. When protective layer 4 was 40 μm or more, neither corrosion of positive electrode collector foil 3 nor peeling of protective layer 4 from positive electrode collector foil 3 occurred. In addition, neither a reduction in the initial capacity of the secondary battery nor a reduction in cycle characteristics were detected, thus confirming that positive electrode 1 which has excellent cycle characteristics and high initial capacity were manufactured. However, when protective layer 4 is more than 100 μm, protective layer 4 can be peeled off from positive electrode collector foil 3, thus making it difficult to form positive electrode mixture layer 2 (applying step). Therefore, when energy density per volume must be high, it is recommended that the average thickness of protective layer 4 be set to be not less than 10 μm and not more than 100 μm. When the average thickness of protective layer 4 is not less than 10 μm and not more than 40 μm, productivity is low, and thus it is more preferable that the average thickness of protective layer 4 be not less than 40 μm and not more than 100 μm.

TABLE 1

| | Thickness of protective layer 4 | | | |
|---|---|---|---|---|
| | to 10 μm | 10 to 20 μm | 20 to 40 μm | 40 to 100 μm |
| Sample 1 | X | ◯ | Δ | ⊚ |
| Sample 2 | X | Δ | ◯ | ⊚ |
| Sample 3 | X | Δ | ◯ | ⊚ |

X: There is considerable corrosion of positive electrode collector foil 3 (formation of positive electrode mixture layer 3 is difficult)
Δ: There is corrosion of positive electrode collector foil 3 (there are bubbles generated on surface, and peeling)
◯: There is slight corrosion (no bubble on surface, but there is peeling)
⊚: No corrosion

### Manufacturing Method of Secondary Battery

The manufacturing method of the secondary battery illustrated in FIGS. 1A to 2B will be described.

First, as illustrated in FIG. 5A, protective layers 4 and positive electrode mixture layers 2 are intermittently formed on both surfaces of long strip positive electrode collector foil 3 for manufacturing a plurality of positive electrodes (positive electrode sheets) 1. The manufacturing method of positive electrode 1 will be described in detail. Slurry including carbon particles 5 and binder 9 is applied to the surface of positive electrode collector foil 3 including aluminum or an aluminum alloy. This slurry is dried and solidified to form protective layer 4. Then, an aqueous solution (slurry) including a positive electrode active material, a binder, and water but not any solvent and having viscosity set to be not less than 5000 mPas and not more than 10000 mPas is applied to protective layer 4. The aqueous solution is then dried and solidified to form positive electrode mixture layer 3. Then, positive electrode 1 is pressed in a thickness direction to be compressed so that the average thickness of protective layer 4 is not less than 10 μm and not more than 100 μm (preferably, not less than 40 μm and not more than 100 μm). Subsequently, in order to obtain positive electrode 1 used for each laminated type battery, positive electrode collector foil 3 is cut along cutting line 90 indicated by a broken line illustrated in FIG. 5A to be divided, thereby obtaining positive electrode 1 having the desired size as illustrated in FIGS. 2A and 5B. Cutting line 90 is a virtual line, not formed in reality.

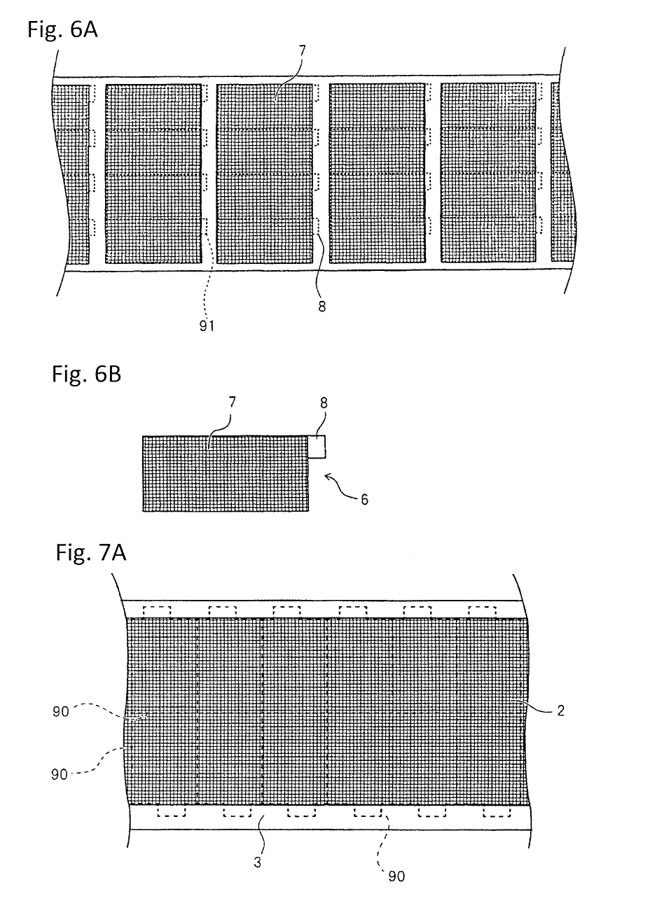

As illustrated in FIG. 6A, negative electrode mixture layers 7 are intermittently formed on both surfaces of long strip negative electrode collector foil 8 for manufacturing a plurality of negative electrodes (negative electrode sheets) 6. Then, in order to obtain negative electrode 6 used for each laminated type battery, negative electrode collector foil 8 is cut along cutting line 91 indicated by a broken line illustrated in FIG. 6A to be divided, thereby obtaining negative electrode 6 having the desired size as illustrated in FIG. 6B. Cutting line 91 is a virtual line, not formed in reality.

Positive electrode 1 illustrated in FIG. 5B and negative electrode 6 illustrated in FIG. 6B, formed in the aforementioned manner, are alternately laminated with separator 20 interposed therebetween, and positive electrode terminal 11 and negative electrode terminal 16 are connected to them to form an laminated electrode. This laminated electrode is housed together with electrolyte 12 in an exterior container including flexible film 30 and sealed, thereby forming secondary battery 100 illustrated in FIGS. 1A and 1B.

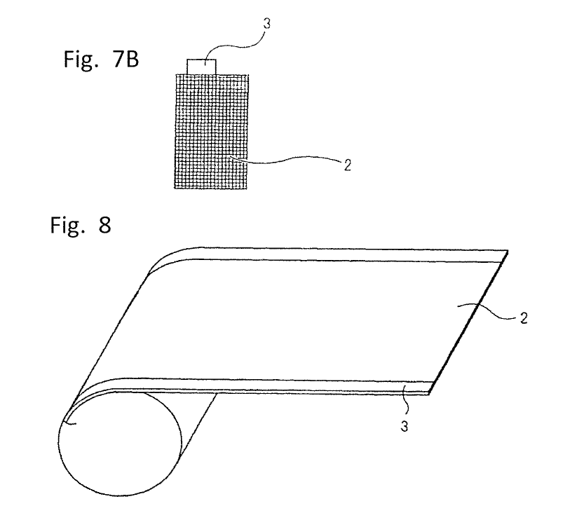

Positive electrode mixture layer 2 and negative electrode mixture layer 7 may be formed not by in coating (intermittent application), but by continuous coating (continuous application) for forming mixture layers without any gaps over a plurality of electrode forming parts as illustrated in FIG. 7A. When a mixture layer is formed by the continuous coating, an electrode roll can be formed to be stored as illustrated in FIG. 8 before cutting along cutting line 90 illustrated in FIG. 7A. While FIGS. 7A to 8 illustrate the case of positive electrode 1, an electrode roll can be similarly formed for negative electrode 6.

The present invention has been described with reference to some exemplary embodiments. However, the present invention is not limited to the exemplary embodiments. Various changes understandable to those skilled in the art can be made to the configuration and details of the present invention within the scope of the technical idea of the invention.

This application claims priority from Japanese Patent Application No. 2014-81732 filed on Apr. 11, 2014, which is incorporated by reference herein in its entirety.

1. A secondary battery comprising:
an laminated electrode in which a positive electrode including positive electrode collector foil and a positive electrode mixture layer and a negative electrode including negative electrode collector foil and a negative electrode mixture layer are arranged with a separator interposed therebetween, wherein:
the positive electrode collector foil is made of aluminum or an aluminum alloy, the positive electrode mixture layer includes a positive electrode active material containing at least nickel and lithium, and a protective layer is formed between the positive electrode collector foil and the positive electrode mixture layer;
the protective layer includes a plurality of carbon particles;
the carbon particles are thin flakes which have a principal plane;
the carbon particles are arranged so that within the protective layer, the principal plane intersects at least a thickness direction of the protective layer; and
an average thickness of the protective layer is not less than 40 μm and not more than 100 μm.

2. (canceled)

3. The secondary battery according to claim 1, wherein the carbon particles are graphite particles.

4. The secondary battery according to claim 1, wherein the laminated electrode is housed together with an electrolyte in an exterior container.

5.-10. (canceled)

11. The secondary battery according to claim 3, wherein the laminated electrode is housed together with an electrolyte in an exterior container.

12. The secondary battery according to claim 1, wherein the protective layer does not include metal oxide.

13. The secondary battery according to claim 3, wherein the protective layer does not include metal oxide.

14. The secondary battery according to claim 4, wherein the protective layer does not include metal oxide.
